(19) United States
(12) Patent Application Publication
(10) Pub. No.: US 2020/0311752 A1
(43) Pub. Date: Oct. 1, 2020

(54) Method of Answering Multiple Questions and Implementation in Surveys

(71) Applicant: Chian Chiu Li, Fremont, CA (US)

(72) Inventor: Chian Chiu Li, Fremont, CA (US)

(21) Appl. No.: 16/900,806

(22) Filed: Jun. 12, 2020

Related U.S. Application Data
(63) Continuation-in-part of application No. 15/412,043, filed on Jan. 22, 2017, now abandoned.

(51) Int. Cl. G06Q 30/02

(52) U.S. Cl. CPC G06Q 30/0203; G06F 3/04842; G06Q 30/0282

(57) ABSTRACT

Systems and methods for answering questions with one answer. In one aspect, multiple survey questions are selected and then addressed with one answer simultaneously. In another aspect, multiple events are addressed with one answer simultaneously. In yet another aspect, multiple events and opinion poll questions are addressed simultaneously.

### FEDERALLY SPONSORED RESEARCH

Not applicable

### SEQUENCE LISTING OR PROGRAM

Not applicable

### CROSS REFERENCE TO RELATED APPLICATION

This is a continuation-in-part of U.S. application Ser. No. 15/412,043, filed Jan. 22, 2017, which is a continuation-in-part of U.S. patent application Ser. No. 14/298,880, filed Jun. 6, 2014, now U.S. Pat. No. 9,607,311, granted Mar. 28, 2017.

### BACKGROUND—FIELD OF INVENTION

This invention relates to the field of electronic device, more particularly to answering multiple questions with one answer. This invention also relates to the field of survey.

### BACKGROUND—DESCRIPTION OF PRIOR ART

Conventional surveys include questions that are answered one by one and a person has to spend some time which always seems too long. But customer surveys are important for all kinds of business. Surveys on social or political issues are also important for policy makers as well as the general public. For business, survey results may be used to monitor customer service, improve product quality, obtain early warnings, observe future trends, etc. Conventional surveys often use a questionnaire that includes multiple questions. The questions are long and not easy to comprehend, and they often occupy several pages. No matter whether a questionnaire is on paper or on a screen, most people just shy away from it because, answering multiple questions takes time.

When there are multiple events, it would be more efficient and timesaving if the events could be surveyed together in a way like surveying a single event. But since conventional surveys have complex questions and answers, it is impossible to address multiple events simultaneously. For instance, answers of conventional survey may include options “extremely satisfied”, “satisfied”, “neither satisfied nor unsatisfied”, “unsatisfied”, and “extremely unsatisfied”. Assume that there are two events to be surveyed. If they could be addressed simultaneously by one action, it would mean that the events have the same answer out of five options, which seems impractical. As a consequence, surveys on multiple events are more tedious and more time-consuming.

Therefore, there exists a need for answering multiple questions more efficiently, a need for a survey that takes less time, and a need for surveying multiple events quickly.

The word “event”, as used herein, is referred broadly as something which physically or virtually happened, is happening, or may happen, and is suitable for conducting a survey. Examples include, but not limited to, shopping, dining, gaming, travelling, service, a class in school, a concert or ritual, political, cultural, religious or sport activities, political, cultural, religious issues and policies, or other personal or collective phenomena. The start of an event may be the beginning of an activity, or the appearance of a subject or issue. Other examples may include the beginning of a shopping activity, the announcement of a policy, the publication of a personal, organizational, or national plan, or the occurrence of any other phenomena. For some long-lasting issues such as attitude towards marriage, education, or politics, the event starting time may be long time ago. The end of event may mean a conclusion, closing, ending, withdrawal, or disappearance.

### OBJECTS AND ADVANTAGES

Accordingly, several main objects and advantages of the present invention are:
a). to provide an improved method to answer multiple questions;
b). to provide such a method that uses one answer to address multiple questions simultaneously;
c). to provide an improved survey;
d). to provide such a survey that is quick and easy to conduct; and
e). to provide such a survey in which multiple events are addressed by one answer simultaneously.

Further objects and advantages will become apparent from a consideration of the drawings and ensuing description.

### SUMMARY

In accordance with the present invention, a method for answering questions includes presenting first content items as questions in an interface of an electronic device, each first content item having a first image; presenting second content items as answers in the interface, each answer corresponding to the questions; in response to selection of a first content item by a user, changing a first image of the first content item to a second image or presenting a third image proximate to the first content item to indicate the selection; and in response to activation of a second content item by the user, using an answer corresponding to the second content item as a response of the user to questions that correspond to first content items selected by the user.

In another aspect, a method for answering questions includes presenting questions in an interface of an electronic device; presenting answers in the interface, each answer corresponding to the questions; in response to selection of a question by a user, changing a first image of the question to a second image or presenting a third image proximate to the question to indicate the selection; and in response to activation of an answer by the user, using the answer as a response of the user to questions that are selected by the user.

In another aspect, a method for answering questions includes presenting first content items displaying respective content of questions in an interface of an electronic device, each first content item having a first image; presenting second content items as answers in the interface, each answer corresponding to the questions; in response to selection of a first content item by a user, changing a first image of the first content item to a second image or presenting a third image proximate to the first content item to indicate the selection; and in response to activation of a second content item by the user, using an answer corresponding to the second content item as a response of the user to questions that correspond to first content items selected by the user.

### DRAWING FIGURES

FIG. 1 is a block diagram describing one embodiment in accordance with the present invention.

FIGS. 2A, 2B, and 2C illustrate graphically embodiments of answering multiple questions in accordance with the present invention.

FIGS. 3 and 4 are flow diagrams depicting one-action multi-event survey and one-action multiple surveys respectively in accordance with the present invention.

FIGS. 5 and 6 are flow diagrams depicting surveys for multiple events in accordance with the present invention.

FIG. 7 is a flow diagram illustrating awarding method in surveys in accordance with the present invention.

FIG. 8 is a flow diagram illustrating a survey embodiment in accordance with the present invention.

FIGS. 9A and 9B illustrate graphically embodiments of answering multiple questions in accordance with the present invention.

### REFERENCE NUMERALS IN DRAWINGS

| | | | |
|---|---|---|---|
| 10 | Client System | 12 | Survey Database |
| 14 | Communication Network | 16 | Processor |
| 18 | Processing Module | 20 | Log Database |
| 22 | Computer Readable Medium | | |
| 24 | Close Button | 26 | Wait Button |
| 28 | Display Surface | 30 | “Yes” Button |
| 31 | Content Item | 32 | “No” Button |
| 33 | Content Item | 34 | “So-So” Button |
| 36 | Button | 38 | Button |
| 40 | Client System | 41 | Content Item |
| 42 | Display Surface | 43 | Content Item |
| 44 | “Yes” Button | 45 | Content Item |
| 46 | “No” Button | 47 | Content Item |
| 48 | “So-So” Button | 49 | Content Item |
| 50 | Button | 52 | Button |
| 61 | Answer Button | 62 | Answer Button |
| 63 | Answer Button | 80 | Client System |
| 82 | Server System | | |
| 100-142 | are exemplary steps. | | |

### DETAILED DESCRIPTION

The following exemplary embodiments are provided for complete disclosure of the present invention and to fully inform the scope of the present invention to those skilled in the art, and the present invention is not limited to the schematic embodiments disclosed, but can be implemented in various types.

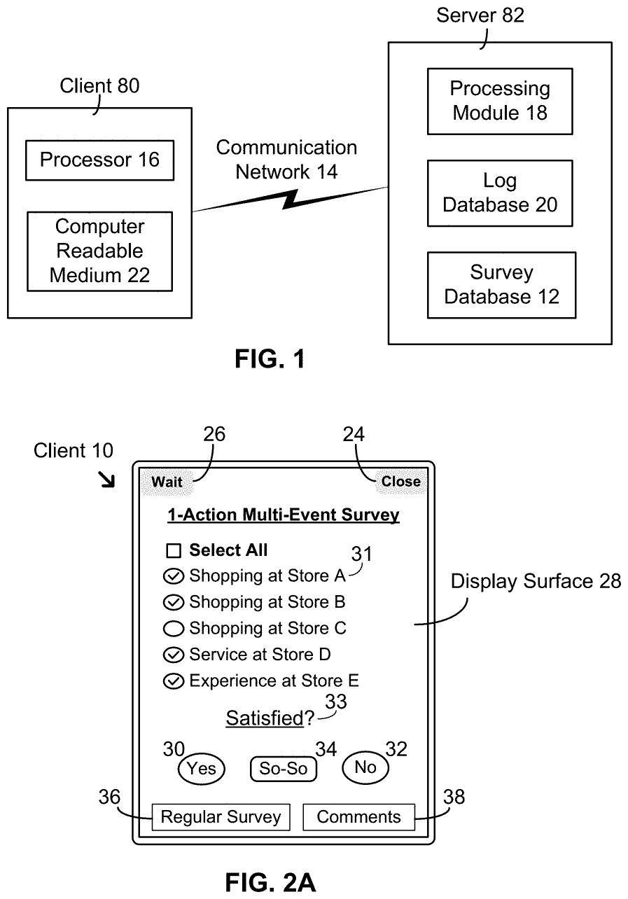

FIG. 1 is an exemplary block diagram of one embodiment according to the present invention. A client system 80 and server system 82 are connected via a communication network 14. Client 80 may represent an electronic device, including but not limited to a desktop computer, a laptop computer, a tablet computer, a smartphone, a smart watch, a virtual reality (VR) device, an augmented reality (AR) device, and the like. Client 80 may include a processor 16 and computer readable medium 22. Processor 16 may mean one or more processor chips or systems. Medium 22 may include a memory hierarchy built by one or more memory chips or storage modules like RAM, ROM, FLASH, magnetic, optical and/or thermal storage devices. Processor 16 may run programs or sets of executable instructions stored in medium 22 for performing various functions and tasks, e.g., surfing on the Internet, playing video or music, conducting a survey, electronic payment, social networking, sending and receiving emails, short messages, files, and data, executing other applications, etc. Client 80 may also include input, output, and communication components, which may be individual modules or integrated with processor 16. Communication components may connect the device to a server or another device via a communication network. Usually, client 80 may have a display (not shown) and a graphical user interface (GUI). A display may have liquid crystal display (LCD) screen, organic light emitting diode (OLED) screen (including active matrix OLED (AMOLED) screen), or LED screen. A screen surface may be sensitive to touches, i.e., sensitive to haptic and/or tactile contact with a user, especially in the case of smart phone, tablet computer, smart watch, and wearable devices. A touch screen may be used as a convenient tool for a user to enter input and interact with a system.

Furthermore, client 80 may have a voice recognition component to receive a verbal command or audio input from a user. In addition, client 80 may have a gesture detection mechanism to receive gesture instructions, such as a command by a hand or finger gesture. For VR and AR devices and some wearable devices, a virtual screen or screen having a very small size may be used. A virtual screen may be part of a virtual display which may not have a physical screen structure. While it is impractical or inconvenient to touch a virtual screen or very small screen, verbal commands and gesture instructions may become useful for a user. In descriptions below, the word “screen”, as used herein, may include a virtual screen and a screen with very small size, e.g., smaller than a one-inch-by-one-inch square or smaller than a fingertip.

The word “server”, as used herein, may indicate a system or systems which may have similar functions and capacities as one or more servers. Main components of a server may include one or more processors, which control and process data and information by executing software, logic, code, or carrying out any other suitable functions. A server, as a computing device, may include any hardware, firmware, software, or a combination thereof. In the most compact form, a server may be built on a single processor chip. In FIG. 1, server 82 may represent one or more server entities that collect, process, maintain, and/or manage survey information and documents, conduct surveys, communicate with users, deliver information required by users, etc. Server 82 may exemplarily be divided into three blocks, represented by a processing module 18, a log database 20, and a survey database 12. Processing module 18 may include processing and communication functions. Log database 20 may store user ID information and survey ID information, which may be used to trace a survey that a user participated in. Survey database 12 may store survey results and other survey related information, such as information on the survey event. The databases may include a cluster of memory chips and/or storage modules.

A communication network 14 may cover a range of entities such as the Internet or the World Wide Web, a local area network (LAN), a wide area network (WAN), a metropolitan area network (MAN), a telephone network, an intranet, wireless, and other types of networks. Client 80 and server 82 may be connected to network 14 by various wired, wireless, optical, or other connections.

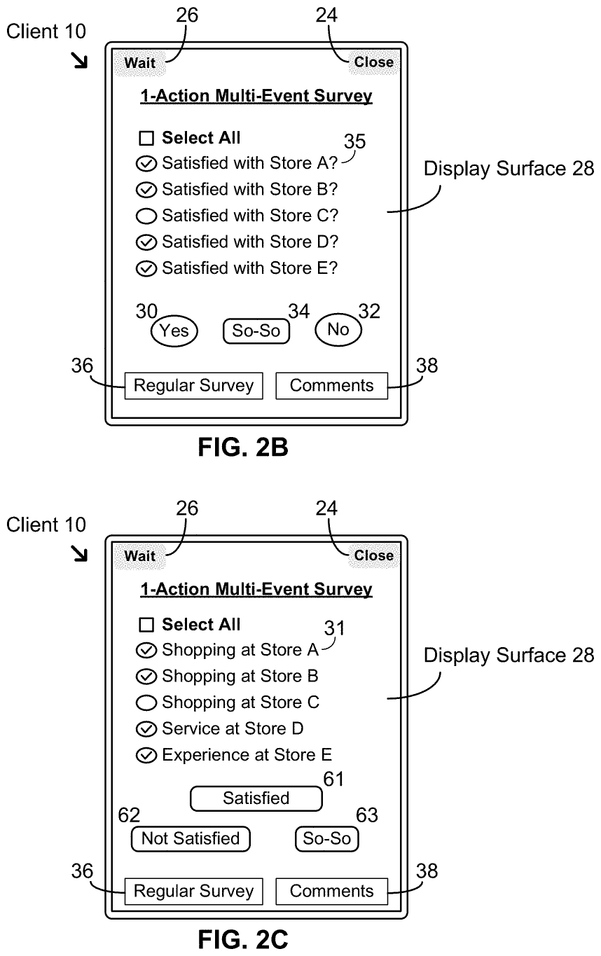

FIGS. 2A, 2B, and 2C are exemplary diagrams of a client system 10 for illustrating embodiments according to the present invention. Client 10 is an electronic device similar to client 80 described above. As shown in FIG. 2A, client 10 has a display surface 28, where information, messages, and interactive graphic objects may be presented. The interactive graphic objects may represent documents, applications, and functions, e.g., a textual file, photo album, browser, email, music, platform, etc. Display surface 28 also shows a GUI by which a user may interact with a client system and a remote server. In some embodiments, surface 28 is a touch screen or touchscreen, which is sensitive to a touch or touches. An interactive graphic object on surface 28 may be selected or activated by a click on a mouse or more conveniently, by a tap using finger tip.

The view on surface 28 of FIG. 2A may be considered as a survey interface or a survey window with a title “1-Action Multi-Event Survey”. There are six events to be surveyed, from a shopping event at store A to an event at store E. Each event is represented by a content item 31 in the interface and the content items 31 form an event list. As aforementioned, events as used herein may be personal, collective, or business related activities, a process or journey, issues of all kinds, or any phenomena. Examples of events may include, online shopping, in-store shopping, dining, service, gaming, show, sport event, travel, educational event, community event, cultural or political policy, an issue, an activity, and so on. In some embodiments, content item 31 may display content of a survey question, such as a description of an event or a subject to be surveyed. A description of an event or a subject may be concise and clear, such as “Shopping at Fresh Market”, “Service at Ed's Auto Body”, “Lunch at Café Cozy”, “New Recycling Policy”, “Performance of Mayor Steve W. W. Harding”, and so on.

There is another content item 33 that displays a question “Satisfied?” beneath the event list. “Satisfied?” applies to all events listed above it. As such, the event list is also a question list that displays questions with respect to the events. For example, “Shopping at Store A” may mean “Are you satisfied with shopping at store A?” as content items 31 and 33 are combined. An event on the event list may be selected by clicking a content item 31 or a sign beside a content item 31. In some embodiment, a check mark may appear after a content item 31 is activated, as shown in FIG. 2A. In some embodiments, a content item 31 may be highlighted, e.g., changing from one image to another image, after activation. The check mark or image change is used to indicate a content item 31, i.e., an event, is selected or one question is selected that will be answered.

Beneath content item 33, there are three interactive graphic objects or three buttons 30, 32 and 34. The buttons correspond to “Y” or “Yes” (satisfied), “N” or “No” (not satisfied), and “So-So” (average), respectively. These are three answers for the survey question, as compared to five or seven answers in a conventional survey. The five conventional answers may be very good, good, average, bad, and very bad. However, such answer format is not only complex, but also impractical for answering multiple questions with one answer.

In real life, users or consumers may be satisfied in many events or most events, e.g., when going shopping now and then around the town, which, after all, is what a business tries very hard to achieve every day. Consequently, answers for most survey questions may be “Satisfied”. A user may use a “Select All” element to choose all questions on the list, and then click or tap the “Y” button to answer the questions with one answer (i.e., Y or yes) in one action. If for instance, a user doesn't like a shopping event at store C, the user may first select all, then uncheck the event at store C, and then click on “Y” button to address the rest four questions with one answer in one action simultaneously. The satisfactory answer may be used as the user's response to the four questions or the four events.

On the other hand, if there are two satisfactory answers, “Satisfied” and “Very Satisfied”, it may be difficult to use one answer to address the questions. Instead, two answers or two rounds may be needed for answering the questions. In addition, a user may have a hard time to distinguish a “Satisfied” event from a “Very Satisfied” event.

There are other graphic objects on the display surface 28. If a user doesn't want to take a survey, he or she may tap a “Close” button 24. There is also a “Wait” button 26 for a user who may need more time to decide. Tapping “Wait” button may keep the survey window open for an extended period of time. On the bottom, a “Regular Survey” button 36 and a “Comments” button 38 are arranged. Button 36 may lead to a survey with a conventional format that has many questions and five or seven answer options. Button 38 is arranged for users who want to write a comment. After button 38 is tapped, a comment pad may open up.

In some embodiments, display surface 28 may show a configuration that is similar to that of FIG. 2A but content items 31 and 33 are moved. As shown in FIG. 2B, content items 35 may replace content items 31 and show multiple questions that form a question list. For example, the first question may display “Satisfied with Store A?” The questions on the list may be selected and then answered together by clicking one of answer buttons 30, 32, or 34. A check mark or highlighting may be used to indicate a question is selected.

In some embodiments, display surface 28 may show a configuration that is similar to that of FIG. 2A but content item 33 and answer buttons 30, 32, and 34 are removed. As shown in FIG. 2C, content items 31 show multiple events that represent multiple questions in the same way as that illustrated in FIG. 2A. There are three answer buttons 61, 62, and 63 beneath the event list. Button 61 displays “Satisfied”, and button 62 displays “Not Satisfied”. As such, answers corresponding to buttons 61, 62, and 63 are directly related to user satisfaction. Hence, separate content item “Satisfied?” (e.g., content item 33 of FIG. 2A) is no longer needed. Similar to the embodiments shown in FIGS. 2A and 2B, content items 31 may be selected partially or completely and then answered together by clicking one of answer buttons 61, 62, or 63.

In some embodiments, instead of three answer buttons, there may be only two answer buttons configured beneath an event list (or a question list), such as yes and no buttons or satisfied and not satisfied buttons. In some embodiments, there may be only one answer button for multiple questions, such as yes button or satisfied button for cases that has a simplified format.

A survey may get started after a user opens a survey app at a smartphone. Then, the user may address multiple events (i.e., multiple questions) using one answer through one action. It is simple, swift, and easy and thus more likely to be accepted by users than a traditional survey. For example, after a user purchases a cup of coffee at a cafe, has hair cut at a barber shop, and sees a movie at a movie theater, the event info may be transmitted to a service center or a survey center by businesses, banks, or other financial institutions. Next, the survey center may send a message to the user's smartphone, assuming the phone is registered for surveys. An alert signal may appear on the smartphone's touch screen or GUI. The user may give a quick tap on the screen to open a survey window. Assuming everything is satisfactory, a one-action multi-event survey may be performed to cover all events at the same time.

Back to FIG. 1, a survey session may be processed by processor 16. Survey alert may be triggered by a survey application installed in the client system. Survey instructions may come from a survey center, a business which conducts or oversees an event, or another party which is informed of the event status. It is noted that a client system such as client 10 or 80 may or may not be involved in a target event. For example, a smartphone may be used for electronic payment and then for answering questions in a survey later on. On the other hand, when a credit card is used for payment, and a smartphone is registered with the survey center, the smartphone may receive instructions for conducting a survey. Survey related information, including the case ID, user ID, survey results, and event info, may be sent to server 82 by processor 16 via network 14. Server 82 may store case ID, survey results, and event info in survey database 12, and keep user ID and case ID in log database 20. Alternatively, survey related information may be transmitted to a local device which then relays the information to a remote server. In addition, processor 16 may send the survey related information to a local device which then passes it to a database. For example, the aforementioned cafe may want to keep to itself the survey data collected from its customers. In some embodiments, it may be configured such that events are accumulated for surveys within a given time frame, which may be a couple of days or a week.

Answering multiple questions with one answer in a survey may save time for a user. Besides, it is also easy for a user to start a conventional survey session by tapping button 36, or post comments by tapping button 38. Additionally, options may be arranged for a user to revisit and revise survey answers within a period of time.

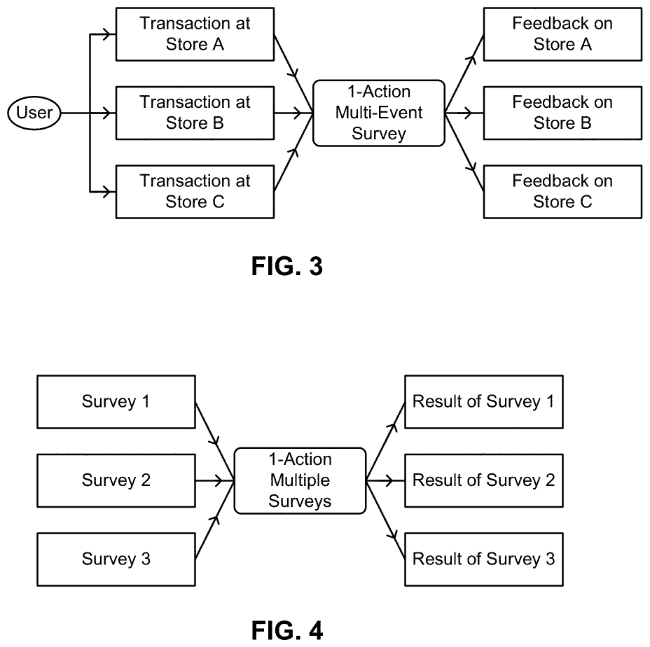

FIGS. 3 and 4 depict survey embodiments by exemplary flow diagrams according to the present invention. In FIG. 3, a user made purchases at stores A, B, and C, respectively. A survey center may obtain the transaction info and arrange a survey session via the user's smart phone, tablet computer, or another device. The user may go through a one-action survey to address all events simultaneously by answering questions with one answer. Next, the result may be recorded and then transmitted to the survey center through a communication network. Survey data on the stores may be sorted and stored at the center.

FIG. 4 describes a similar scenario. A user may have participated in several events and may be presented with surveys 1, 2, and 3 through a survey center. A session may be arranged to conduct all three surveys together. Then one-action multiple surveys may take place, where each survey is represented by a question. Results on the three surveys may be obtained simultaneously and then recorded after the user addresses the surveys with one answer. Then, survey results and other related info may be sent to the survey center that aggregates survey data and store the data in respective groups.

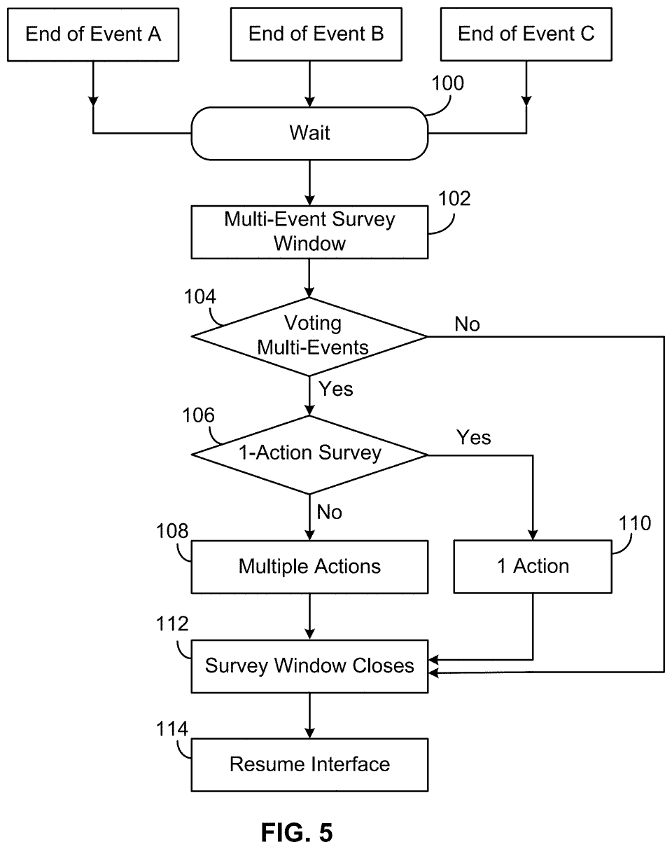

FIG. 5 shows a schematic flow diagram of a multi-event survey process in more details. Assume a user takes part in events A, B and C, respectively. Going back to FIG. 1, after the events start or end, relevant info concerning the user and the events is sent to server 82, which in turn transmits messages to the user's device, such as client system 80. As mentioned, client 80 may represent various electronic devices, including a smartphone or a computer at home. Returning to FIG. 5, the messages may instruct client 80 to wait before starting a survey session, as in step 100. Next in step 102, the user may start a survey app by clicking on a survey symbol, and a survey window may show up with the three events in an event list on a display of client 80. In step 104, the user may select to proceed with the survey or refuse it by closing the window. For the latter instance, step 112 happens, the session is ended, and client 80's interface may resume its previous configuration in step 114. If no action is taken, the survey window may close by itself within a predetermined period of time.

If a user moves ahead with the survey in step 104, he or she may choose one-action method to address three events together, as in step 110. In such a circumstance, it is presumed that the three events may be addressed together. The user may also choose to do step 108 for a conventional survey process, where traditional questions and answers are prepared, and thus multiple actions are needed. After the survey is done, the survey window is closed in step 112, and a prearranged or previous interface appears in step 114. After the user selects events and then activate an answer button, client 80 may obtain survey results the user inputs, record it, and send the survey results to a survey center or server 82. The obtaining, recording, and sending steps may be carried out by the survey app or software familiar to those skilled in the art.

Before a survey gets started, it is appropriate or often required to get permission, authorization, or consent from a user. Especially when a survey is conducted by a third party, such as a survey center which is not related to any event, a user may want to make sure that personal and survey related info would be used properly and within a limit. User consent may allow surveys to be conducted without the need of getting permission each time. For example, a user may install an application at a smartphone or computer to set up a system for survey sessions. During the installation process, the user may be asked to give authorization for conducting surveys and to submit personal information for creating an account. The submitted information is then transferred to a facility of survey center, e.g., server 82 of FIG. 1. The info may be stored at database 20. Then after a user shows up in an event, like dining at a restaurant, the restaurant, under an agreement or contract, may send event and user info to the survey center, which in turn may send a message to a device registered with the user, and to prompt a survey session, or add one more event to a survey list prepared for the user. When surveys become easy, quick, and rewarding (as discussed below), a user may be willing to take the surveys on lots of daily events.

Since many daily activities may become eligible events to be surveyed, a user may not know what event would happen in advance, but nonetheless may face it in a survey at a later time. For instance, a user may not foresee all stores in which he or she would make a purchase before entering a shopping mall. And for every transactions made at the mall, the user knows it would show up on a survey list later. Thus for a user, there are always some events which may happen without any plan; but once an event takes place, the user knows a corresponding survey would follow. This feature differentiates it from conventional surveys, where a user either knows a future event and a survey are bundled, or doesn't have any knowledge of a survey when taking part in an event.

FIG. 6 is an exemplary flow diagram of one embodiment according to the present invention, which covers user authorization and events with and without schedules. First in step 116, a user gives permission, authorization, or consent to a survey service, including allowing a third party to get necessary information about the user and relevant events for survey purposes. For instance, a user name, account ID, account password, and telephone number are among the information to be collected. If the user refuses to give consent, the process comes to an end in step 117. If the user agrees with the requirement and conditions and wants to do surveys, consent and other info are sent to the survey service. Later on, the user may go through two types of events. In step 120, events or activities are planned in advance. For example, a user may have schedules for grocery shopping at a particular supermarket before setting off from home. In step 118, events to be encountered are not planned or even unaware before it happens. For instance, for a previously undecided shopping act, or impromptu buying spree, a shopping plan or event schedule doesn't exist. Because a user is enrolled in a survey program after submitting authorization and completing a registration process, he or she knows a survey would happen after an event starts or ends, no matter whether or not the event is known to the user in advance. Accordingly afterwards, a multi-event survey session may begin at the user's device in step 121, and the user may choose how to do it in step 122. In step 124, a one-action survey is provided for a quick process, while step 126 indicates a conventional survey procedure which requires multiple actions to answer questions one after another.

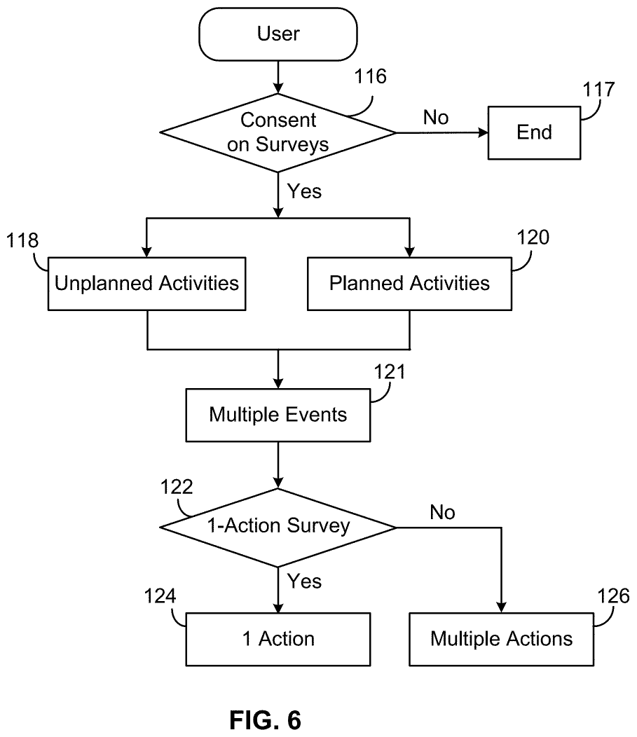

FIG. 7 shows a schematic flow diagram of another embodiment, which describes an awarding scheme, according to the present invention. For instance, it may be designed such that a user is awarded financially every time a survey is performed or a question is answered. The award, for example, may be of addible points. The amount of point for each event may be decided by an event owner, e.g. a business owner, or by a survey center which provides the service. Points may be redeemable for a product or gift. Event owners may be responsible for point redemption collectively, as the redemption may take points from several events. For instance, a user may participate in multiple events in step 128, complete multiple surveys in step 130, and gain rewarding points in step 132. In step 134, the points earned are added up, which may be redeemed.

Because of the resistance and difficulties to do surveys, a user rarely takes a survey to evaluate daily activities. In the practice of conventional surveys, participants are usually promised to have a chance to win a raffle prize, or are compensated by a small gift. The effect of raffle prize is limited. Small gift may be unattractive and yet costly to a business. Normally a user may take no more than one survey during a long time. If a user does complete a couple of surveys, the surveys are likely conducted by unrelated organizations. Therefore, it is out of the question or unrealistic to add up small awards of surveys. But when events to be surveyed happen on a daily basis, or happen many times a week, it becomes desirable to add up survey benefits together for a reward which cannot be redeemed with the benefit from a single event. Therefore, step 134 introduces a method which encourages users to do more surveys, and to earn more points.

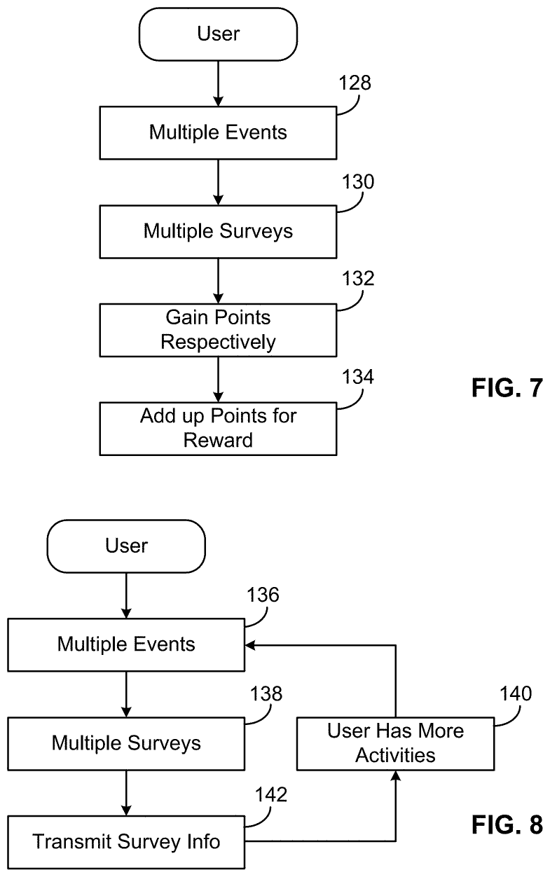

Another exemplary flow diagram of an embodiment is illustrated in FIG. 8. Again, a user goes through multiple events in step 136, and completes multiple surveys in step 138. In step 142, survey related info is transmitted to a survey database, such as database 12 and 20 of FIG. 1. Next the events-surveys-info-transfer process may repeat itself as time goes by and the user participates in additional activities in step 140, which leads to more events to be surveyed. Currently, most events are not associated with surveys, and a user has no knowledge until getting a survey invitation. However, when surveys become ubiquitous and a norm, most events are included in surveys as long as a user is registered with a survey service provider, and thus there is no need to schedule a survey ahead of time. Readiness of a survey session may depend upon events. Once events occur, surveys may be arranged by a survey center automatically. Events, on the other hand, depend upon activities of a user, since the activities create events to be surveyed. The mechanism is reflected by steps 140, 136, and 138. The cycle may keep going, which is yet another feature conventional surveys clearly lack.

In descriptions above, a survey question is focused on satisfaction regarding a user's experience, such as “Satisfied?”, “Are You Satisfied?” and so on. But the satisfaction question may not apply to some event or subject. For instance, if a survey is about “Shopping at Gadget Store”, question “Satisfied?” is suitable. But if a survey is arranged to find a users' opinions or attitude toward an issue, a proposal, or a policy, a question like “Agree?” may be more appropriate. For instance, given survey subjects such as “0.1% Sales Tax Increase for School Improvement” or “Proposal to Build New Bay Bridge”, “Agree?” or “Agree with?”, instead of “Satisfied?”, is the right question.

When surveys to be conducted deal with opinions on issues as well as experiences, questions “Satisfied?” and “Agree?” may be presented together so that one action may still complete multiple surveys. For instance, “Satisfied or Agree?”, “Satisfied/Agree?”, or “Satisfied/Agree with?” may represent a compact form of two questions. The combined questions are also easy to comprehend and easy to answer simultaneously with yes, no, or so-so answer.

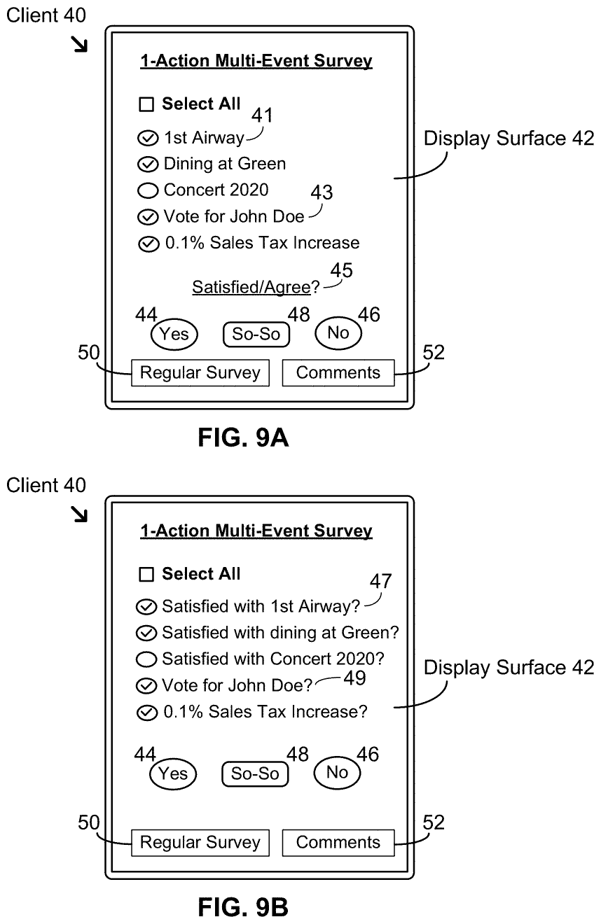

FIGS. 9A and 9B illustrate schematically survey embodiments that have opinion poll questions. As shown in FIG. 9A, a client system 40 presents a survey interface on a touch-sensitive display surface 42. A survey session is titled “1-Action Multi-Event Survey”. There are content items 41 and 43 that represent different types of questions. Content items 41 may display content of events which a user participated in, while content items 43 may display content of subjects which are related to an opinion, proposal, and/or policy. For example, content items 43 may display “Vote for John Doe” and “0.1% Sales Tax Increase”. Also presented in the interface is a content item 45 that shows “Satisfied/Agree?” for addressing content items 41 and 43, respectively. Interactive buttons 44, 46, and 48 are answer buttons for yes, no, and so-so. When combined with content item 45, answer button 44 represents satisfied or agreeable and answer button 46 represents not satisfied or disagreeable. Thus, questions provided by content items 41 and 43 may be addressed by one answer through one action simultaneously.

In practice, a user may tap “Select All” to select all content items 41 and 43, de-select one of them if something occurred, and then tap yes button 44 to answer the selected questions simultaneously. Thus, survey questions and opinion poll questions may be addressed together in one action. As such, a survey and an opinion poll may be combined and a user may answer them in one action.

In some embodiments as shown in FIG. 9B, a survey interface is similar to that shown in FIG. 9A but content items 41 and 43 are replaced by content items 47 and 49, respectively. In addition, content item 45 is removed. Content items 47 and 49 may display survey questions and opinion poll questions directly. For example, one survey question may be “Satisfied with 1st Airway?” and an opinion poll question may be “Vote for John Doe?”. The questions may be addressed by answer button 44, 46, or 48 directly. A user may select multiple questions, and then activate one of the answer buttons to respond to the questions with one answer in one action simultaneously. Hence, a survey and an opinion poll may be conducted together. Survey questions and opinion poll questions may be answered by one response simultaneously.

Other objects presented in the interface may include interactive buttons 50 and 52 which provide two more options. A user may tap button 50 to open a new window where traditional surveys may be prepared for each event. A user may select one traditional survey and answer questions one by one. When a user wants to post reviews or comments on an event or an issue, the user may tap button 52 to open a writing space.

### CONCLUSION, RAMIFICATIONS, AND SCOPE

Thus it can be seen that systems and methods are introduced for conducting improved surveys.

The improved surveys have the following main features and advantages:
(1). Multiple questions are addressed with one answer simultaneously;
(2). Multiple events are addressed with one action in a survey; and
(3). Survey questions and opinion poll questions are answered with one action simultaneously.

Although the description above contains many specificities, these should not be construed as limiting the scope of the invention but as merely providing illustrations of some of the presently preferred embodiments. Numerous modifications will be obvious to those skilled in the art.

### Ramifications:

With a survey configuration such as that shown in FIG. 2B or 9B, the answers provided in a survey interface are yes, no, and so-so. Hence, in some embodiments, any survey question that fits the yes, no, or so-so answer may be chosen and presented to a user. Suitable questions may have a wide range, far beyond a satisfaction question. In some embodiments, a survey question may be more complex, have more words, or have a longer sentence than those described above.

Events to be surveyed may also include an experience which is personal for a user, such as an experience or feels of a certain period of personal life, a certain period of family life, a cultural or religious custom, and so on. For instance, a survey may be held on feels of a personal habit, like attitude toward smoking, which is personal but reflects a social aspect, or an experience of a spiritual activity.

Besides click and tap, vocal instructions may also be used to select events and submit an answer, if a user's device is equipped with a voice recognition system. Such a method may be favored when VR and AR devices are involved, since input using hand becomes unavailable. For instance, after a survey interface similar to that of FIG. 9A shows up on a virtual screen, a user may speak to a VR device, “Select all” and “De-select Concert 2020” to choose events. Then the user may say “Answer is yes” or “Yes”, which equals to tapping button 44, to complete the multi-event surveys. Similarly, the selecting and voting process may be completed via gesture instructions.

Lastly, various smartphone positioning technologies may be utilized to qualify a user for a survey. For instance, once it is detected that a user's device enters the perimeter of a venue, such as a park, zoo, entertainment site, seminar room, concert hall, the info may be transmitted to a survey center. Then the user may be enrolled in a survey on his or her experience at the venue.

Therefore the scope of the invention should be determined by the appended claims and their legal equivalents, rather than by the examples given.

1. A computer implemented method performed for answering questions comprising:
presenting a plurality of first content items as a plurality of questions in an interface of an electronic device, each first content item having a first image;
presenting a plurality of second content items as a plurality of answers in the interface, each answer corresponding to the plurality of questions;
in response to selection of one of the plurality of first content items by a user, changing a first image of the one of the plurality of first content items to a second image or presenting a third image proximate to the one of the plurality of first content items to indicate the selection; and
in response to activation of one of the plurality of second content items by the user, using one of the plurality of answers as a response of the user to one or more of the plurality of questions, wherein the one of the plurality of answers corresponds to the one of the plurality of second content items, and the one or more of the plurality of questions correspond to one or more of the plurality of first content items that are selected by the user.

2. The method according to claim 1 wherein the plurality of questions include one or more survey questions.

3. The method according to claim 1 wherein at least one of the plurality of questions corresponds to an event which the user participated in.

4. The method according to claim 1 wherein the plurality of first content items display content of the plurality of questions, respectively.

5. The method according to claim 1 wherein one of the plurality of questions is related to user satisfaction, user attitude, or user opinion.

6. The method according to claim 1 wherein the plurality of questions include an opinion poll question.

7. The method according to claim 1 wherein the plurality of answers include at least one of a positive answer or a negative answer.

8. A computer implemented method performed for answering questions comprising:
presenting a plurality of questions in an interface of an electronic device;
presenting a plurality of answers in the interface, each answer corresponding to the plurality of questions;
in response to selection of one of the plurality of questions by a user, changing a first image of the one of the plurality of questions to a second image or presenting a third image proximate to the one of the plurality of questions to indicate the selection; and
in response to activation of one of the plurality of answers by the user, using the one of the plurality of answers as a response of the user to one or more of the plurality of questions that are selected by the user.

9. The method according to claim 8 wherein the plurality of questions include one or more survey questions.

10. The method according to claim 8 wherein at least one of the plurality of questions corresponds to an event which the user participated in.

11. The method according to claim 8, further including presenting an interactive element in the interface, the interactive element representing an option of a survey.

12. The method according to claim 8 wherein all of the plurality of questions are related to user satisfaction, user attitude, or user opinion.

13. The method according to claim 8 wherein the plurality of questions include an opinion poll question.

14. The method according to claim 8 wherein the plurality of answers include at least one of a positive answer or a negative answer.

15. A computer implemented method performed for answering questions comprising:
presenting a plurality of first content items displaying respective content of a plurality of questions in an interface of an electronic device, each first content item having a first image;
presenting a plurality of second content items corresponding to a plurality of answers in the interface;
in response to selection of one of the plurality of first content items by a user, changing a first image of the one of the plurality of first content items to a second image or presenting a third image proximate to the one of the plurality of first content items to indicate the selection; and
in response to activation of one of the plurality of second content items by the user, using one of the plurality of answers as a response of the user to one or more of the plurality of questions, wherein the one of the plurality of answers corresponds to the one of the plurality of second content items, and the one or more of the plurality of questions correspond to one or more of the plurality of first content items that are selected by the user.

16. The method according to claim 15 wherein the plurality of questions include one or more survey questions.

17. The method according to claim 15 wherein at least one of the plurality of questions corresponds to an event which the user participated in.

18. The method according to claim 15 wherein one of the plurality of questions is related to user satisfaction, user attitude, or user opinion.

19. The method according to claim 15 wherein the plurality of questions include an opinion poll question.

20. The method according to claim 15 wherein the plurality of answers include at least one of a positive answer or a negative answer.
